(19) United States
(12) Patent Application Publication
(10) Pub. No.: US 2020/0202764 A1
(43) Pub. Date: Jun. 25, 2020

(54) DRIVING METHOD FOR DISPLAY

(71) Applicant: Raydium Semiconductor Corporation, Hsinchu (TW)

(72) Inventors: JUN-REN SHIH, Hsinchu City (TW); SHANG-PING TANG, Hsinchu City (TW); WEN-TENG FAN, Hsinchu (TW)

(21) Appl. No.: 16/718,320

(22) Filed: Dec. 18, 2019

(30) Foreign Application Priority Data
Dec. 21, 2018 (TW) 107146530

(51) Int. Cl. G09G 3/20

(52) U.S. Cl. CPC G09G 3/20; G09G 2320/0233; G09G 2310/0275; G09G 2310/0267; G09G 2310/06

(57) ABSTRACT

A display driving method is disclosed. The display driving method includes the following steps: (A) generating a gate driving signal having a turn-on period by a gate driver; (B) generating a source driving signal by a source driver; the source driving signal has a first waveform corresponding to a first region and has a second waveform corresponding to a second region; (C) outputting, by a controller of a display device, a first control signal to allow the second waveform to be similar to the first waveform in the turn-on period.

### BACKGROUND OF THE INVENTION

### 1. Field of the Invention

The invention relates to a display driving method for a display signal; in particular, to a display driving method for a driving integrated circuit.

### 2. Description of the Prior Art

Due to advances in display technology, a range of a display area of a display can be increased. For example, the range of the display area can be larger by the narrow border technology. However, when the display area is increased, the area (i.e., the non-display area) where the components originally arranged on the front of the display are located will be limited. For example, as the display area increases, the boundary between the display area and the non-display area will change, resulting in the need to adjust the wirings in the display area, and the brightness may be uneven during display. Therefore, how to improve the uniformity of the display brightness of the conventional display has become an important issue.

### SUMMARY OF THE INVENTION

Therefore, the invention provides a display driving method to improve the uniformity of the display brightness.

An embodiment of the invention is a display driving method. In this embodiment, the display driving method includes the following steps of: (A) using a gate driver to generate a gate driving signal having an ON period; (B) using a source driver to generate a source driving signal, wherein the source driving signal has a first waveform corresponding to a first area and a second waveform corresponding to a second area; and (C) a controller of a display outputting a first control signal to make the second waveform approach the first waveform during the ON period.

The advantage and spirit of the invention may be understood by the following detailed descriptions together with the appended drawings.

### BRIEF DESCRIPTION OF THE APPENDED DRAWINGS

FIG. 1 is a schematic diagram of an embodiment of a display.

FIG. 2 is a schematic diagram of a display area and a non-display area.

FIG. 3 is a flowchart of an embodiment of a display driving method.

FIG. 4 is a schematic diagram of an embodiment of adjusting a driving signal.

FIG. 5 is a schematic diagram of another embodiment of adjusting the driving signal.

FIG. 6 is a flowchart of another embodiment of the display driving method.

FIG. 7 is a schematic diagram of another embodiment of adjusting the driving signal.

FIG. 8 is a flowchart of another embodiment of a display driving method.

FIG. 9 is a schematic diagram of another embodiment of adjusting the driving signal.

FIG. 10 is a schematic diagram of a display area and a non-display area.

### DETAILED DESCRIPTION OF THE INVENTION

Reference will now be made in detail to the exemplary embodiments, the same or similar reference numbers or components used in the drawings and the embodiments are used to represent the same or similar parts.

FIG. 1 is a schematic diagram of an embodiment of a display 1. As shown in FIG. 1, the display 1 has a display surface 10. The display surface 10 includes a display area 12 and a non-display area 14. A concave portion 16 is disposed on a side of the display area 12, and the non-display area 14 is disposed in the concave portion 16. For example, the concave portion 16 is disposed on a side of the display area 12 and extends from the side toward the center of the display area 12. As shown in FIG. 1, among the sides around the display area 12, the side close to the non-display area 14 forms a boundary of a zigzag curve.

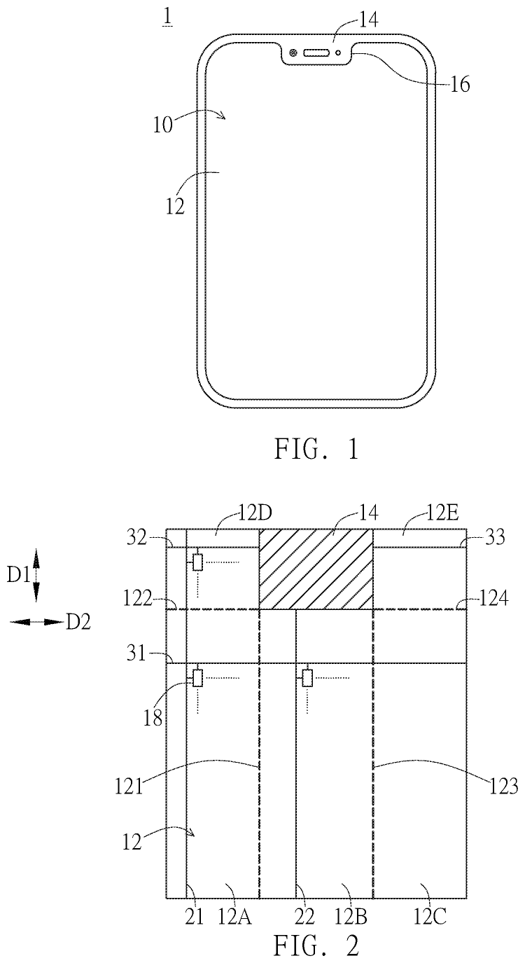

FIG. 2 is a schematic diagram of the display area 12 and the non-display area 14. As shown in FIG. 2, the display area 12 includes an area 12A to an area 12E, wherein the area 12A is adjacent to the area 12B. The area 12B is connected to the concave portion (i.e., the non-display area 14). The concave portion where the non-display area 14 is located is in the center of a short side of the display area 12 (i.e., a side close to the area 12D and the area 12E in FIG. 2). Further, different areas in the display area 12 can be distinguished by the edges of the concave portion. As shown in FIG. 2, the area 12A has a boundary 121 and a boundary 122 connecting the boundary 121. The area 12B connects the area 12A along the boundary 121. Generally speaking, the aforementioned area is defined by the position of the edge or the end of the concave portion. Taking the area 12B as an example, the concave portion extends from the boundary 121 to the boundary 123 in the direction D2, and the area 12B is a band-shaped area corresponding to the boundary 121 to the boundary 123. Taking the area 12D as an example, the concave portion extends from the edge of the display area 12 to the boundary 122 in the direction D1, and the area 12D is a band-shaped area corresponding to the edge of the display area 12 to the boundary 122.

The pixels 18 in the display area 12 are connected to a source line and a gate line respectively. In the example of FIG. 2, the display 1 includes a first source line 21 in the driving area 12A and a second source line 22 in the driving area 12B. The first source line 21 and the second source line 22 are distributed in a parallel direction D1. As shown in FIG. 2, the length of the second source line 22 is smaller than the length of the first source line 21. In other words, the source line distributed in the area 12A and the source line distributed in the area 12B have different lengths.

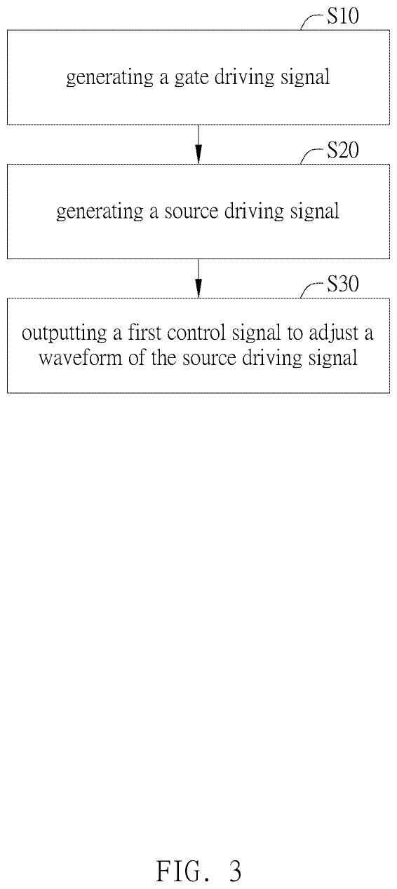

FIG. 3 is a flowchart of an embodiment of a display driving method. As shown in FIG. 3, the display driving method includes steps S10, S20 and S30. The display driving method includes a stage of generating a driving signal and a stage of adjusting a waveform of a source driving signal. In the step S10, a gate driver is used to generate a gate driving signal having an ON period. In the step S20, a source driver is used to generate a source driving signal. The source driving signal has a first waveform corresponding to the area 12A and the source driving signal also has a second waveform corresponding to the area 12B. In the step S30, the controller of the display outputs a first control signal, so that the second waveform approaches the first waveform during the ON period. The waveform of the source driving signal is adjusted by the first control signal, so that the waveform of the source driving signal corresponding to the area 12B approaches the waveform of the source driving signal corresponding to the area 12A.

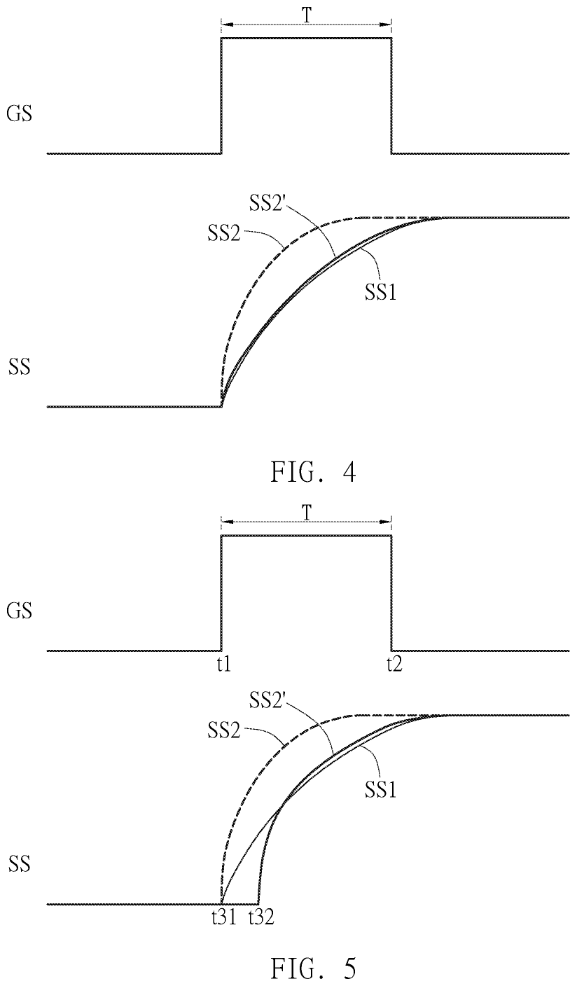

FIG. 4 is a schematic diagram of an embodiment of adjusting the driving signal. As shown in FIG. 4, the gate driving signal GS has the ON period T. The source driving signal SS has different types corresponding to different areas of the display area. For example, the source driving signal SS1 corresponds to the area 12A and the source driving signal SS2 corresponds the area 12B. As shown in FIG. 4, before the source driving signal is adjusted, the waveform of the source driving signal SS1 and the waveform of the source driving signal SS2 are different. Furthermore, because the lengths of the source lines distributed in different areas of the display area are different, the loads of the source lines in different areas are different, so the waveforms of the source driving signals corresponding to different areas are different. In the above case, when different areas (such as the area 12A and the area 12B) display the same gray scale, the brightness of the area 12A and the area 12B may be different. For example, the adjustment of the source driving signal SS is to adjust the driving force of different output pins of the source driver according to the first control signal. As shown in FIG. 4, after the source driving signal SS is adjusted, the source driving signal corresponding to the area 12B is changed from the original source driving signal SS2 to the source driving signal SS2′, so that the waveform of the source driving signal SS2′ approaches the waveform of the source driving signal SS1.

In the example of FIG. 4, a smaller driving force is provided to the source line having a smaller load, so that the waveforms of the source driving signals in different areas are close, and the brightness of the areas 12A and 12B tends to be the same. Preferably, the waveform of the source driving signal SS2′ and the waveform of the source driving signal SS1 substantially overlap during the entire ON period T of the gate driving signal GS, so as to provide the effect of uniform brightness of the display area.

Please refer to FIG. 2, FIG. 3 and FIG. 4. As shown in FIG. 2, the display area 12 includes an area 12C. The area 12C has a boundary 123 and a boundary 124 connecting to the boundary 123. The area 12B connecting to the area 12C along the boundary 123. Similarly, for the areas 12B and 12C, the waveforms of the source driving signals can be adjusted in the manner shown in FIG. 3 and FIG. 4, so that the display brightness of the areas 12B and 12C can be approximated.

FIG. 5 is a schematic diagram of another embodiment of adjusting the driving signal. As shown in FIG. 5, the gate driving signal GS has the ON period T. The ON period T is from a start time t1 to an end time t2. As mentioned before, before the source driving signal is adjusted, the waveforms of the source driving signal SS1 and the source driving signal SS2 are different, so that the brightness of the areas 12A and 12B may be different. For example, the first control signal may be a delay signal, and the gate driving signal is adjusted according to the first control signal (i.e., the delay signal) to adjust an enabling time of the source driver. As shown in FIG. 5, after the source driving signal is adjusted, the source driving signal corresponding to the area 12B is changed from the original source driving signal SS2 to the source driving signal SS2′, so that the waveform of the source driving signal SS2′ approaches the waveform of the source driving signal SS1.

In the example of FIG. 5, the enable time of the source driving signal corresponding to the source line having a smaller load is delayed (the source driving signal corresponding to the second area is changed from the enable time t31 to the enable time t32). In addition, after the waveform is changed, the enabling time of the source driving signal SS2′ lags behind the enabling time of the source driving signal SS1. As a result, the waveforms of the source driving signals in different areas will approach to each other, so that the brightness of the areas 12A and 12B becomes uniform. As shown in FIG. 5, according to the first control signal (i.e., the delay signal), near the end time t2, a part of the waveform of the source driving signal SS2′ and the waveform of the source driving signal SS1 substantially overlap. In one embodiment, the overlapped portion of the waveform occupies more than 50% of the ON period T, so as to improve the brightness uniformity of the display area.

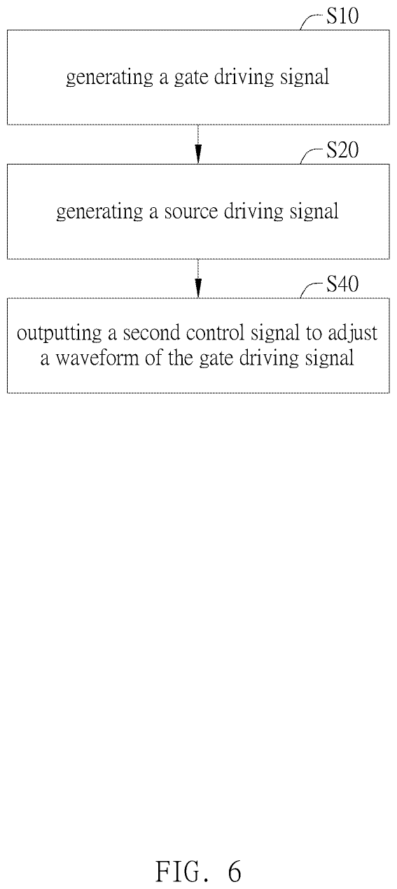

FIG. 6 is a flowchart of another embodiment of the display driving method. As shown in FIG. 6, the display driving method includes steps S10, S20 and S40. The display driving method includes a stage of generating a driving signal and a stage of adjusting a waveform of a gate driving signal. Please refer to FIG. 2 and FIG. 6, the display area 12 further includes an area 12D. As shown in FIG. 2, the area 12A has a boundary 121 and a boundary 122 connecting to the boundary 121. The area 12D connects to the area 12A along the boundary 122. In the example of FIG. 2, the display device 1 includes a first gate line 31 driving the area 12A and a second gate line 32 driving the area 12D. The length of the second gate line 32 is smaller than the length of the first gate line 31. In other words, the gate lines distributed in the area 12A and the gate lines distributed in the area 12D have different lengths. In addition, the second gate line distributed in the area 12D and the gate line 33 distributed in the area 12E have the same length.

As shown in FIG. 6, in the step S10, a gate driving signal is generated by a gate driver, and the gate driving signal corresponding to the area 12A has a third waveform and the gate driving signal corresponding to the area 12D has a fourth waveform. In the step S20, a source driving signal is generated by the source driver. In the step S40, the controller of the display device outputs a second control signal, so that the fourth waveform approaches the third waveform. The waveform of the gate driving signal is adjusted by the second control signal, so that the waveform of the gate driving signal corresponding to the area 12D approaches the waveform of the gate driving signal corresponding to the area 12A.

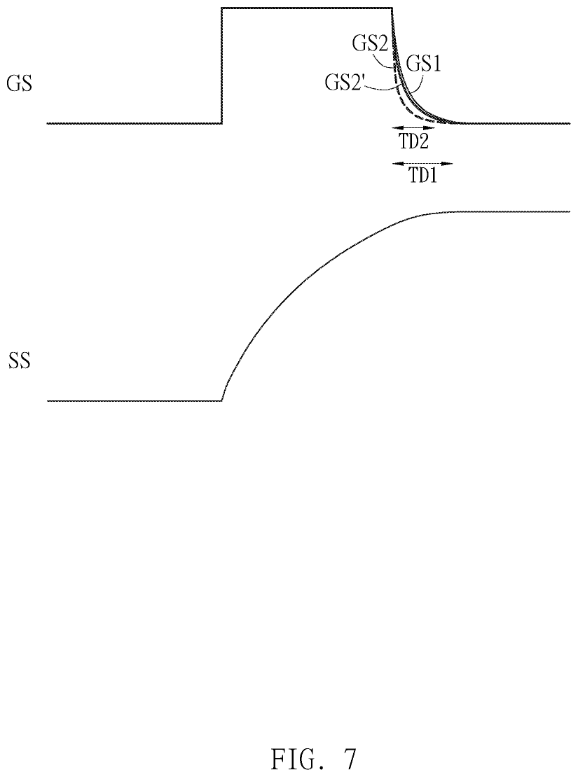

FIG. 7 is a schematic diagram of another embodiment of adjusting the driving signal. As shown in FIG. 7, the areas 12A and 12D have the same source driving signal SS. The gate driving signal GS has different types corresponding to different areas of the display area. The gate driving signal GS1 corresponds to the area 12A and the gate driving signal GS2 correspond the area 12D. As shown in FIG. 7, before the gate driving signal is adjusted, the waveform of the gate driving signal GS1 is different from the waveform of the gate driving signal GS2. Further, because the gate line lengths of different areas distributed in the display area are different, the loads of the gate lines in different areas are different, and thus the waveforms of the gate driving signals corresponding to different areas are different. In the above case, when different areas (such as the area 12A and the area 12D) display the same gray scale, the brightness of the area 12A and the area 12D may be different. For example, the gate driving signal is adjusted according to the second control signal to adjust the OFF time of the gate driver to different gate lines. As shown in FIG. 7, after the gate driving signal is adjusted, the gate driving signal corresponding to the area 12D is changed from the original gate driving signal GS2 to the gate driving signal GS2′, so that the waveform of the gate driving signal GS2′ approaches the waveform of the gate driving signal GS1.

In the example of FIG. 7, the OFF time of the gate driving signal corresponding to the gate line having a smaller load is delayed, so that the waveforms of the gate driving signals in different areas approach to each other, so that the brightness of the areas 12A and 12D tends to be consistent. In an embodiment, the aforementioned waveforms are close, which means that the falling edges of the gate driving signals substantially overlap. As shown in FIG. 7, the falling edge of the gate driving signal GS1 has a delay time TD1. Before the gate driving signal GS1 is adjusted, the falling edge of the gate driving signal GS2 has a delay time TD2. After the gate driving signal GS1 is adjusted, the delay time of the falling edge of the gate driving signal GS2′ is substantially the same as the delay time TD1. In other words, according to the second control signal, the falling edge of the gate driving signal GS2′ and the falling edge of the gate driving signal GS1 are substantially overlapped to provide the effect of uniform brightness in the display area.

Please refer to FIG. 2, FIG. 6 and FIG. 7. As shown in FIG. 2, the display area includes an area 12E. The area 12C has a boundary 123 and a boundary 124 connecting to the boundary 123. The area 12E connects the area 12C along the boundary 124. Similarly, for the areas 12C and 12E, the waveforms of the gate driving signals can be adjusted in the manner shown in FIG. 6 and FIG. 7, so that the display brightness of the areas 12C and 12E can be approximated.

It should be added that the display driving method can select the signal type to be adjusted according to the design of the concave portion of the display. Please refer to FIG. 2, the concave portion where the non-display area 14 is located is in the center of the short side (i.e., the side close to the area 12D and the area 12E in FIG. 2). For example, when the size of the concave portion in the direction D1 becomes small, a narrow strip is formed on the side edge and distributed along the direction D2. The source line lengths of the various areas of the display area 12 are not significantly different. In this case, you can choose to adjust the waveform of the gate driving signal (refer to FIG. 6) to adjust the brightness of each area of the display area 12. In another example, the concave portion where the non-display area 14 is located is in the center of the long side, when the size of the concave portion in the direction D2 becomes small to form a narrow strip located on the side edge and distributed in the direction D1, the gate line length of each area of the display area 12 is not significantly different. In this case, the waveform of the source driving signal can be adjusted (refer to FIG. 3) to adjust the brightness of each area of the display area 12.

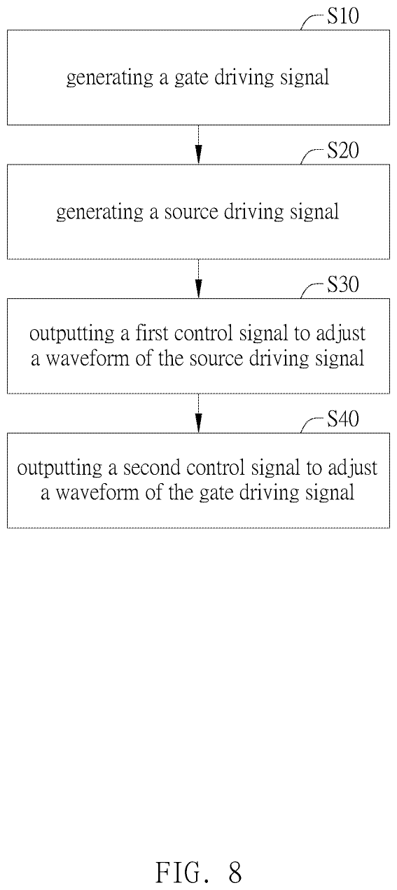

When the trace lengths of the areas adjacent to the concave portion in the display area are different, the waveform of the gate driving signal and the waveform of the source driving signal can be adjusted. Please refer to FIG. 8. FIG. 8 is a flowchart of another embodiment of a display driving method. As shown in FIG. 8, the display driving method includes steps S10-S40. The display driving method includes stages of generating a driving signal, adjusting a waveform of a source driving signal, and adjusting a waveform of a gate driving signal. In the step S10, the gate driver is used to generate the gate driving signal. In the step S20, the source driver is used to generate the source driving signal. In the step S30, the controller outputs a first control signal to adjust the waveform of the source driving signal. In the step S40, the controller outputs a second control signal to adjust the waveform of the gate driving signal.

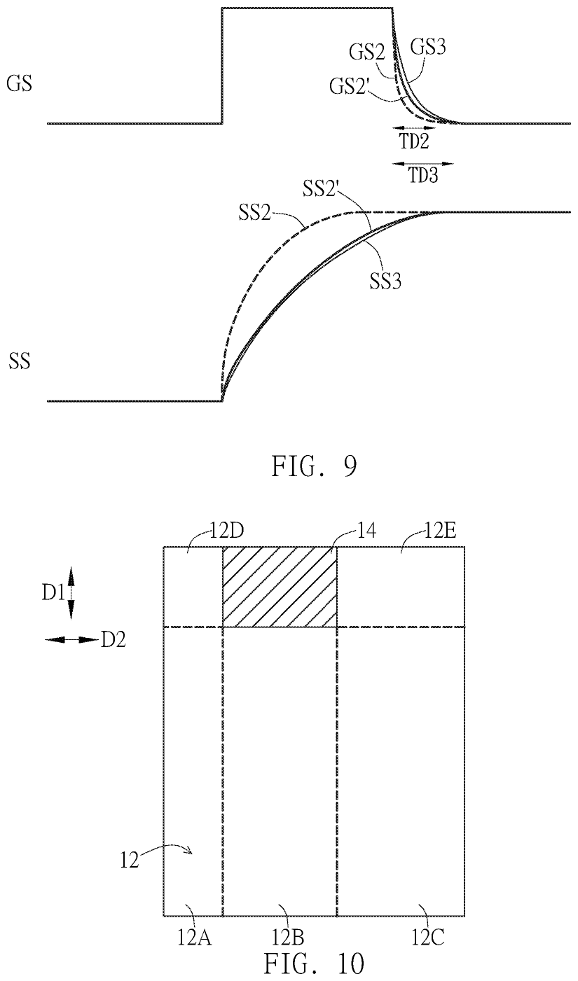

Please further refer to FIG. 2 and FIG. 9. FIG. 9 is a schematic diagram of another embodiment of adjusting the driving signal. Take the areas 12B and 12D in FIG. 2 as examples. The first source line 21 drives the areas 12A and 12D, and the first gate line 31 drives the areas 12A and 12B. The length of the first source line 21 is different from the length of the second source line 22. The length of the first gate line 31 is different from the length of the second gate line 32. As shown in FIG. 9, the area 12B and the area 12D have different source driving signals SS and gate driving signals GS. It is the source driving signal SS2 corresponding to the area 12B and it is the source driving signal SS3 corresponding to the area 12D. It is the gate driving signal GS3 corresponding to the area 12B and it is the gate driving signal GS2 corresponding to the area 12D.

For the gate driving signal, the second control signal outputted by the controller is used to adjust the time that the gate driver turns off the different gate lines. After the gate driving signal is adjusted, the gate driving signal corresponding to the area 12D is changed from the original gate driving signal GS2 to the gate driving signal GS2′, so that the waveform of the gate driving signal GS2′ will approach the waveform of the gate driving signal GS3. And, the ON period is also adjusted accordingly.

In an embodiment, the waveform approaching the gate driving signal means that the falling edges of the gate driving signal substantially overlap. Taking FIG. 9 as an example, the falling edge of the gate driving signal GS3 has a delay time TD3. Before the gate driving signal is adjusted, the falling edge of the gate driving signal GS2 has a delay time TD2. After the gate driving signal is adjusted, the delay time of the falling edge of the gate driving signal GS2′ is substantially the same as the delay time TD3. In other words, the falling edge of the gate driving signal GS2′ and the falling edge of the gate driving signal GS3 are substantially overlapped according to the second control signal to provide a uniform brightness effect in the display area.

On the other hand, as to the source driving signal, the first control signal outputted by the controller is used to adjust the driving force of the different output pins of the source driver. After the source driving signal is adjusted, the source driving signal corresponding to the area 12B is changed from the original source driving signal SS2 to the source driving signal SS2′, so that the waveform of the source driving signal SS2′ will approach the waveform of the source driving signal SS3 in the adjusted ON period. This provides the uniform brightness effect in the display area.

FIG. 10 is a schematic diagram of the display area 12 and the non-display area 14. As shown in FIG. 10, the concave portion where the non-display area 14 is disposed is located on a position shifted from the center on the short side (e.g., the side near the area 12D and the area 12E in FIG. 10). In the embodiment of FIG. 10, the length of the gate line driving the area 12A, the length of the gate line driving the area 12D and the length of the gate line driving the area 12E are different from each other. The display can provide the control signal through the controller, so that the waveforms of the gate driving signals in the above areas are substantially the same. For example, the waveform of the gate driving signal corresponding to the area 12D approaches the waveform of the gate driving signal corresponding to the area 12A, and the waveform of the gate driving signal corresponding to the area 12E approaches the waveform of the gate driving signal corresponding to the area 12D. This provides the uniform brightness effect in the display area.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A display driving method applied to a display, the display having a display surface comprising a display area and a non-display area, a concave portion being disposed on a side of the display area and the non-display area being disposed in the concave portion; the display area comprising a first area and a second area adjacent to the first area; the second area being connected to the concave portion; the display comprising a first source line driving the first area and a second source line driving the second area; a length of the second source line being smaller than a length of the first source line; the display driving method comprising steps of:
(A) using a gate driver to generate a gate driving signal having an ON period;
(B) using a source driver to generate a source driving signal, wherein the source driving signal has a first waveform corresponding to a first area and a second waveform corresponding to a second area; and
(C) a controller of the display outputting a first control signal to make the second waveform approach the first waveform during the ON period.

2. The display driving method of claim 1, wherein the ON period comprises an end time, the first control signal is a delay signal, the display driving method further comprises a step of:
the controller outputting the delay signal to make an enabling time of the second waveform lag behind an enabling time of the first waveform, and make the second waveform and the first waveform substantially overlap when the end time is near.

3. The display driving method of claim 1, wherein the display area further comprises a third area; the first area has a first boundary and a second boundary connecting to the first boundary; the second area connects to the first area along the first boundary; the third area connects to the first area along the second boundary; the display comprises a first gate line driving the first area and a second gate line driving the third area; a length of the second gate line is smaller than a length of the first gate line; the display driving method comprising steps of:
the gate driving signal having a third waveform corresponding to the first area and a fourth waveform corresponding to the third area; and
the controller outputting a second control signal to make the fourth waveform approach the third waveform.

4. The display driving method of claim 3, wherein a falling edge of the third waveform and a falling edge of the fourth waveform have a delay time; the falling edge of the fourth waveform and the falling edge of the third waveform substantially overlap according to the second control signal.

5. The display driving method of claim 3, wherein the first source line drives the first area and the third area; the first gate line drives the first area and the second area; the display driving method further comprises steps of:
the source driving signal having a fifth waveform corresponding to the third area;
the gate driving signal having a sixth waveform corresponding to the second area; and
the controller outputting the first control signal to make the second waveform approach the fifth waveform during the ON period and outputting the second control signal to make the fourth waveform approach the sixth waveform.

6. The display driving method of claim 5, wherein a falling edge of the sixth waveform and a falling edge of the fourth waveform have another delay time; the falling edge of the fourth waveform and the falling edge of the sixth waveform substantially overlap according to the second control signal.
